(19) United States
(12) Patent Application Publication
(10) Pub. No.: US 2015/0076304 A1
(43) Pub. Date: Mar. 19, 2015

(54) CLIP AND CLIP DEVICE

(71) Applicant: Piolax, Inc., Yokohama-shi, Kanagawa (JP)

(72) Inventor: Ryu Hattori, Yokohama-shi (JP)

(21) Appl. No.: 14/389,696

(22) PCT Filed: Mar. 26, 2013
(86) PCT No.: PCT/JP2013/002034

§ 371 Date: Sep. 30, 2014

(30) Foreign Application Priority Data
Apr. 2, 2012 (JP) 2012-084140

(51) Int. Cl. F16B 2/24; B60R 13/00; F16M 13/02

(52) U.S. Cl. CPC F16B 2/245; F16M 13/022; B60R 13/00
USPC 248/231.81

(57) ABSTRACT

A clip device is configured from a clip and a member to be mounted. The clip has: a first member which has a free end; a second member which faces the first member and which has a free end; clamping claws which are respectively formed on the first member and the second member; and a protrusion section which is formed on the first member and/or the second member, is located closer to the free end than the clamping claw, and protrudes between the first member and the second member. The member to be mounted has a guide wall which is formed along a predetermined insertion direction of the clip and which faces a side of the protrusion section and limits the movement of the protrusion section in the width direction.

### TECHNICAL FIELD

The present invention relates to a clip for clamping a mounting-subject member, and a clip device including the mounting-subject member and the clip.

### BACKGROUND ART

A garnish clip is used for mounting a mounting-subject member such as a decoration part on a mount-base member provided to a vehicle body in an automobile (see Patent Document 1). The clip for mounting a component includes a pair of faced pieces that is made by folding back a spring leaf in a V shape and includes an open end and a folded end. A retaining member engageable into a mounting hole is provided to a portion closer to the open end of the pair of faced pieces of the clip. A locking portion configured to lock a resin protruding portion of the mounting-subject member is provided to a portion closer to the folded end of the pair of faced pieces.

### CITATION LIST

### Patent Literature

### Patent Document 1

### SUMMARY OF THE INVENTION

### Problem that the Invention is to Solve

In the technique disclosed in Patent Document 1, when the resin protruding portion is inserted between the pair of faced pieces, the clip can freely move in the width direction until the resin protruding portion is brought into contact with the locking portion positioned close to the folded end of the clip. Thus, the clip could be mounted inclined to a predetermined insertion direction of the resin protruding portion depending on a mounting manner.

The present invention is made in view of the above problem, and an object of the present invention is to provide a technique for preventing a clip from being mounted with inclining to a mounting-subject member.

### Means for Solving the Problem

In order to solve the problem described above, an aspect of the present invention provides a clip device including a clip and a mounting-subject member to be clamped by the clip. The clip device being configured to mount the mounting-subject member on a mount-base member by locking the clip in a state of clamping the mounting-subject member on a rim of a hole portion of the mount-base member. The clip includes: a first member having a free end; a second member faced to the first member and having a free end; clamping hooks respectively provided to the first member and the second member and configured to clamp the mounting-subject member; and an extending portion provided to at least one of the first member and the second member at a position closer to the free ends than the clamping hooks, so as to extend between the first member and the second member. The mounting-subject member includes: a guide wall that is disposed along a predetermined clip insertion direction so as to face a lateral side of the extending portion, thereby limiting a movement of the extending portion in a width direction when the clip clamps the mounting-subject member.

According to the present embodiment, because the movement of the extending portion in the width direction is limited by the guide wall when the clip clamps the mounting-subject member, the clip can be prevented from being mounted to the mounting-subject member while inclined to the predetermined clip insertion direction.

### Advantageous Effects of Invention

According to the present invention, the clip can be prevented from being mounted inclined to a mounting-subject member.

### BRIEF DESCRIPTION OF THE DRAWINGS

FIG. 1 is a perspective view of a clip device according to an embodiment of the present invention.

FIG. 2A is a perspective view of a clip seen from above, and FIG. 2B is a perspective view of the clip seen from below.

FIG. 3A is a side view of the clip, FIG. 3B is a front view of the clip, and FIG. 3C is a top view of the clip.

FIG. 4A is a perspective view of a mounting-subject member, and FIG. 4B is a view of the mounting-subject member seen from the insertion side.

FIG. 5 is a cross-sectional view of the clip device taken along the line A-A of FIG. 1.

FIG. 6 is a front view of a clip of a modified example.

### MODE FOR CARRYING OUT THE INVENTION

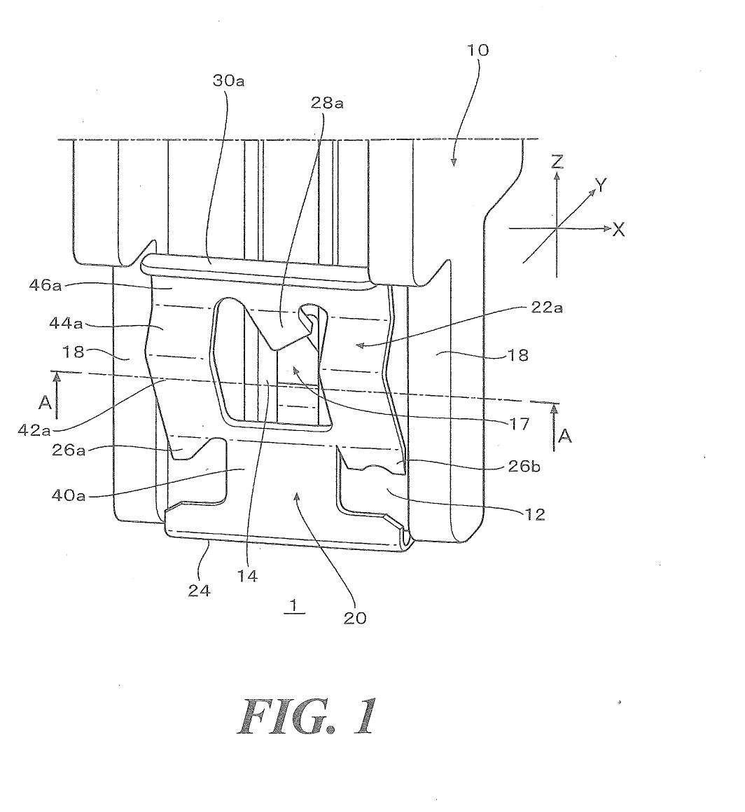

FIG. 1 is a perspective view of a clip device 1 according to an embodiment of the present invention. Shown in FIG. 1 is a state where a clip 20 clamps a mounting-subject member 10. The clip device 1 includes the clip 20 and the mounting-subject member 10 that the clip 20 clamps. The mounting-subject member 10 defines a decoration part made from resin such as a decorative laminate, a control panel, and a package trim to be mounted inside an automobile. In FIG. 1, a part of the mounting-subject member 10 is shown where a protruding portion 12 to be inserted into a hole portion of a mount-base member is shown. It is also possible that a plurality of protruding portions 12 are provided to the mounting-subject member 10, and clips 20 each clamp the protruding portions 20.

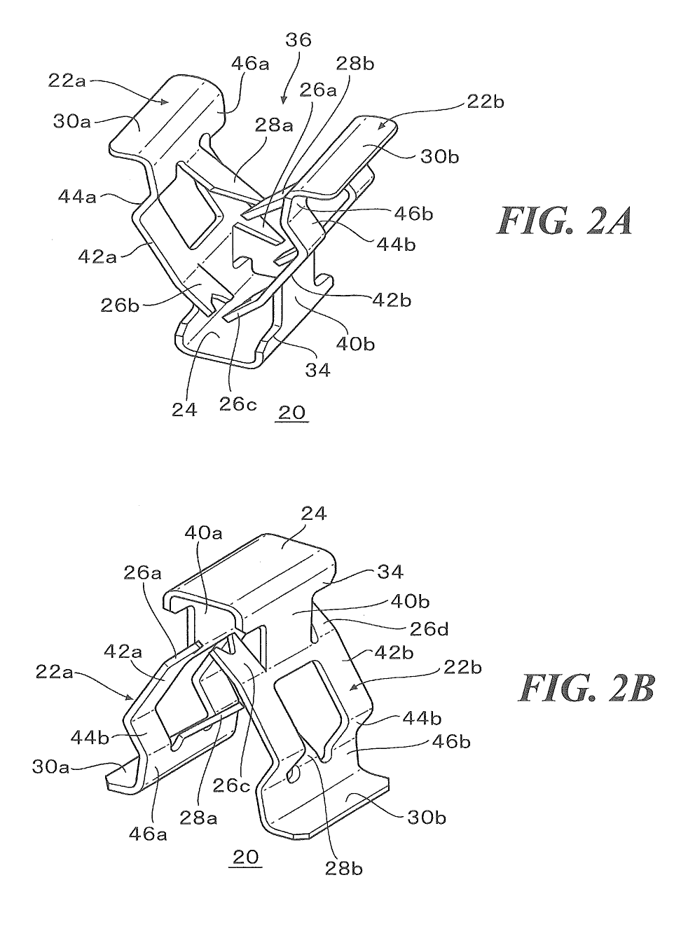

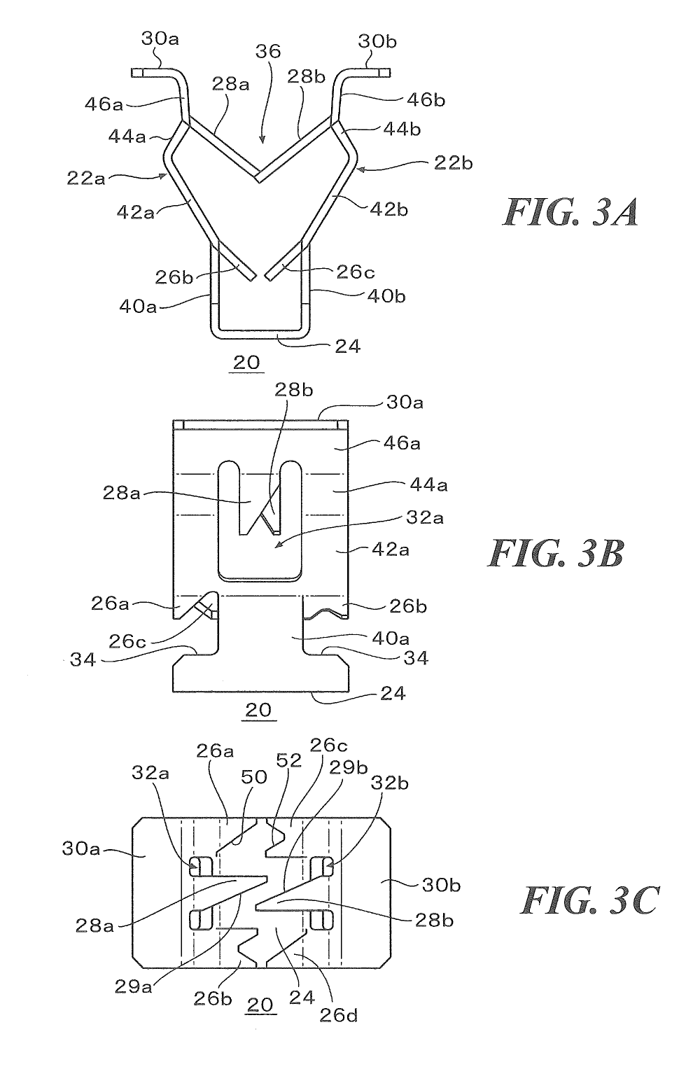

The mounting-subject member 10 is mounted on the mount-base member (not illustrated) by making the clip 20 lock a rim of a hole portion of the mount-base member in a state where the clip 20 clamps the mounting-subject member 10. The clip 20 is made by subjecting a single metallic plate to punching and press working. A detailed description of the clip 20 will be provided with reference to FIG. 2 and FIG. 3.

FIG. 2A is a perspective view of the clip 20 seen from above, and FIG. 2B is a perspective view of the clip 20 seen from below. FIG. 3A is a side view of the clip 20, FIG. 3B is a front view of the clip 20, and FIG. 3C is a top view of the clip 20. In the drawings, same or equivalent components are denoted with same reference numerals, and repeated descriptions of the same or equivalent components are omitted as appropriate.

The X-axis direction shown in FIG. 1 defines a direction along the board width of a first member 22a shown in FIG. 3B, and is referred to as a width direction of the clip 20. In addition, the Y-axis direction shown in FIG. 1 defines a direction in which the first member 22a and the second member 22b shown in FIG. 3A are faced to each other, and is referred to as a lateral direction of the clip 20. The Z-axis direction shown in FIG. 1 defines an up/down direction of the clip 20 shown in FIGS. 3A and 3B.

The clip 20 includes the first member 22a, the second member 22b faced to the first member 22a, and a connecting portion 24 configured to connect the first member 22a and the second member 22b. One ends of the first member 22a and the second member 22b are free ends while the other ends are connected with the connecting portion 24. The connecting portion 24 has a planar shape, and is easy to push when the clip 20 is inserted into the mounting-subject member 10.

The free ends of the first member 22a and the second member 22b define a slot 36 to be inserted into the mounting-subject member 10 as shown in FIG. 2A. The first member 22a includes a lower planar potion 40a standing on the connecting portion 24, bent portions 42a that are bent outward from the lower planar potion 40a, a locking portion 44a that is bent inward from the bent portions 42a and capable of locking the hole rim of the mount-base member, an upper planar portion 46a, and a widening portion 30a that is widened outward, which are arranged in this order from the side of the connecting portion 24. As like the first member 22a, the second member 22b includes a lower planar potion 40b, bent portions 42b, a locking portion 44b, an upper planar portion 46b, and a widening portion 30b, which are arranged in this order from the side of the connecting portion 24. That is, the first member 22a and the second member 22b have symmetrical shapes. The locking portion 44a and the locking portion 44b (referred to as “the locking portions 44” when they are not distinguished from each other) are configured to retain the clip device 1 by locking the rim of a hole portion of the mount-base member when the clip device 1 is mounted on the mount-base member.

The first member 22a and the second member 22b include a first clamping hook 26a, a second clamping hook 26b, a third clamping hook 26c, and a fourth clamping hook 26d (referred to as “the clamping hooks 26” when they are not distinguished from one another) configured to clamp the mounting-subject member 10. The first clamping hook 26a is faced to the third clamping hook 26c while the second clamping hook 26b is faced to the fourth clamping hook 26d, and each pair of faced clamping hooks 26 is configured to clamp the mounting-subject member 10. The tip ends of the metallic clamping hooks 26 may dig into the resin mounting-subject member 10.

The first member 22a includes a first extending portion 28a extending between the first member 22a and the second member 22b. The second member 22b includes a second extending portion 28b extending between the first member 22a and the second member 22b. The first extending portion 28a and the second extending portion 28b (referred to as “the extending portions 28” when they are not distinguished from each other) are disposed at positions closer to the free ends than the clamping hooks 26. The extending portions 28 extend from the position closer to the free ends than the locking portions 44 while the clamping hooks 26 extend inward from the position closer to the connecting portion 24 than the locking portions 44 as shown in FIGS. 3A and 3B. Voids 32a, 32b are provided around the extending portions 28 of the first member 22a and the second member 22b.

There are a space between the first clamping hook 26a and the third clamping hook 26c and a space between the second clamping hook 26b and the fourth clamping hook 26d, and they are slightly apart as shown in FIG. 3C so that the mounting-subject member 10 is easy to be inserted thereinto. Thus, a plate of another clip 20 may stuck into the spaces or may get into the spaces, and an entanglement of the clips 20 with each other may occur. After being subjected to press working, clips 20 are sometimes transported in a group during surface processing, heat treatment, transport before mounting, and the like. If the clips 20 are entangled with each other, mounting operation becomes complicated to require time. Thus, the first extending portion 28a and the second extending portion 28b extend so as to approach each other, and the tip end portions thereof extend so as to cross each other when seen from the lateral side. Thus, the slot 36 of the clip 20 is almost closed by the first extending portion 28a and the second extending portion 28b, which can reduce the possibility that the clips 20 are entangled with each other.

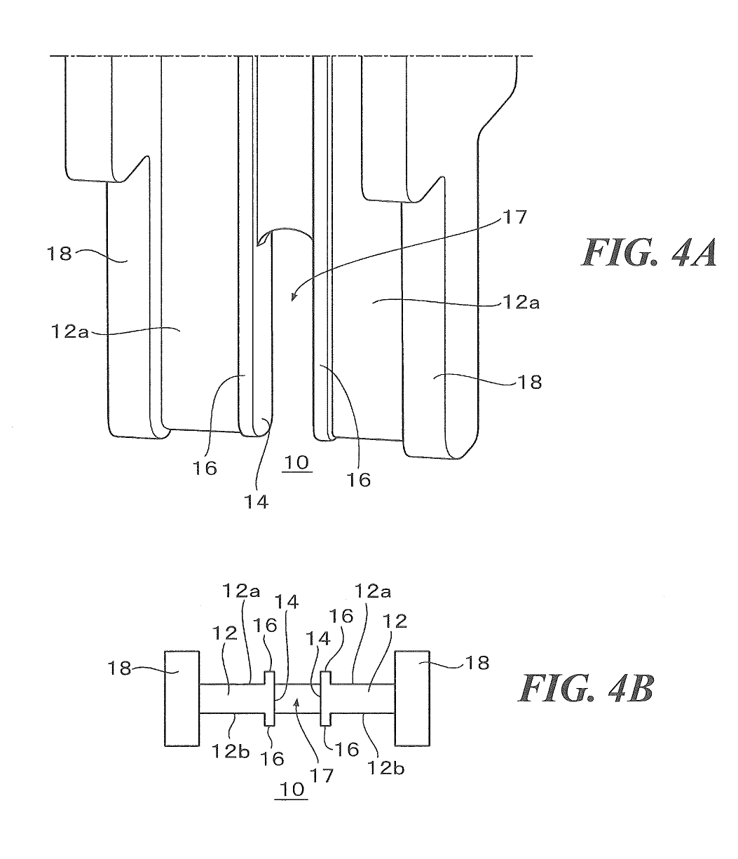

The first member 22a and the second member 22b are flexible for the sake of its elasticity. Disposing the clamping hooks 26 so as to extend inward from the side lower than the centers in the longitudinal directions of the first member 22a and the second member 22b allows the first member 22a and the second member 22b to be more flexible on the free end sides than the sides of the clamping hooks 26 when the clip device 1 is inserted into the hole portion of the mount-base member. A detailed description of the mounting-subject member 10 will be provided with reference to FIG. 4.

FIG. 4A is a perspective view of the mounting-subject member 10, and FIG. 4B is a view of the mounting-subject member 10 seen from the insertion side. In FIGS. 4A and 4B, a protruding portion 12 that the clip 20 clamps is illustrated, and the other components are omitted. The protruding portion 12 protrudes to have an approximately planar shape.

When being clamped by the clip 20, a first surface 12a of the protruding portion 12 abuts against the first clamping hook 26a and the second clamping hook 26b while a second surface 12b that is the back surface to the first surface 12a abuts against the third clamping hook 26c and the fourth clamping hook 26d.

A slit 17 is provided to the protruding portion 12 of the mounting-subject member 10 in the center in the width direction. The slit 17 is made by notching the mounting-subject member 10 from the tip end of the protruding portion 12 that defines the side where the clip 20 is inserted.

Guide walls 14 define a pair of wall surfaces forming the slit 17, and are disposed along a predetermined clip insertion direction. The predetermined clip insertion direction defines, for example, a direction extending vertically from the tip end of the protruding portion 12, and a direction orthogonal to the width direction of the protruding portion 12. The guide walls 14 are configured to limit movement of the extending portions 28 in the width direction when the clip 20 clamps the mounting-subject member 10. Thus, the clip 20 can be prevented from clamping the mounting-subject member 10 while inclined in the width direction to the mounting-subject member 10.

Side end wall portions 18 are provided to the protruding portion 12 at both the ends in the width direction and formed in accordance with the board width of the clip 20. In addition, ribs 16 that extend along the guide walls 14 and form a part of the guide walls 14 are provided. The ribs 16 and the side end wall portions 18 protrude from the first surface 12a and the second surface 12b of the protruding portion 12. Providing the ribs 16 allows the extending portions 28 to be easily brought into contact with the guide walls 14.

The spaces between the ribs 16 and the side end wall portions 18 are formed in accordance with the widths of the clamping hooks 26. Thus, movement of the clamping hooks 26 in width direction can be limited between the ribs 16 and the side end wall portions 18 protruding from the first surface 12a and the second surface 12b of the protruding portion 12.

The extending portions 28 are each disposed in the centers in the width directions of the first member 22a and the second member 22b as shown in FIG. 1. Two pairs of clamping hooks 26 are disposed at outer positions in the width directions than the extending portions 28. For example, the first extending portion 28a is disposed between the first clamping hook 26a and the second clamping hook 26b in the width direction of the clip 20. Thus, the clamping can be stabilized by the two pairs of clamping hooks 26 while the size in the width direction of the clip 20 can be minimized.

In addition, in inserting the clip 20, since the movement of the extending portions 28 is limited by the guide walls 14 prior to clamping hooks 26, the hooks 26 can be prevented from biting into the resin mounting-subject member 10 while the clip 20 is inclined to the predetermined clip insertion direction.

While the pair of extending portions 28 extends so as to cross each other in the direction seen from the lateral side, the tip end portions are disposed apart from each other as shown in FIG. 3C. In addition, an inclined side 29a of the first extending portion 28a is inclined to the faced second member 22b while an inclined side 29b of the second extending portion 28b is inclined to the faced first member 22a. Thus, when the bent portions 42a and the bent portions 42b abut against the rim of the hole portion of the mount-base member in inserting the clip device 1 into the hole portion of the mount-base member, the extending portions 28 are brought into contact with each other, which allows the first member 22a and the second member 22b from warping inward.

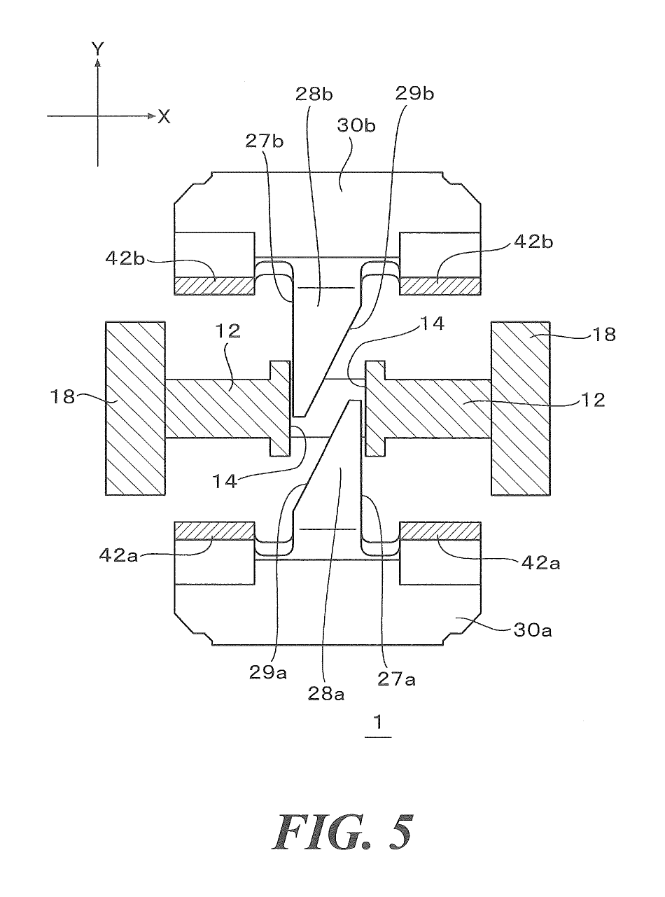

FIG. 5 is a cross-sectional view of the clip device 1 taken along the line A-A of FIG. 1. FIG. 5 is a view of the clip device 1 seen from the lower surface side. The tip end portions of the first extending portion 28a and the second extending portion 28b are inserted between the pair of guide walls 14.

A lateral side 27a of the first extending portion 28a and a lateral side 27b of the second extending portion 28b extend along the lateral direction. The lateral side 27a of the first extending portion 28a and the lateral side 27b of the second extending portion 28b are faced to the guide walls 14 therearound, so that movement of the first extending portion 28a and the second extending portion 28b in the width direction can be limited. Thus, the clip 20 can be prevented from being inserted while inclined in the width direction to the mounting-subject member 10.

Meanwhile, the widening portions 30a, 30b and the bent portions 42a, 42b are apart in the lateral direction from the protruding portion 12, and the first extending portion 28a and the second extending portion 28b are apart in the lateral direction from each other, too. In addition, the faced inclined sides 29a, 29b of the first extending portion 28a and the second extending portion 28b are apart in the width direction from each other while being parallel to each other when seen from the lower surface side. Thus, the first member 22a and the second member 22b of the clip 20 can warp in the lateral direction. In addition, providing the inclined side 29a and the inclined side 29b can ensure the board widths of the extending portions 28 at the base portions, which can secure the rigidity of the extending portions 28.

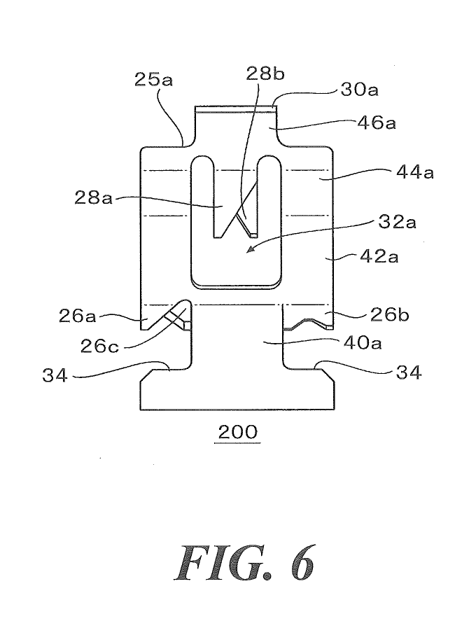

FIG. 6 is a front view of a clip 200 of a modified example. Compared with the clip 20 shown in FIG. 3B, the clip 20 of the modified example is different in that notches 25a are provided to the widening portion 30a and the upper planar portion 46a at both the ends in the width direction. That is, the notches 25a are disposed on the corner portions on the free end side of the first member 22a. For example, each length in the width direction of the notches 25a may be as long as or longer than the length in the width direction of each band-shaped bent portion 42a. While shown in FIG. 6 is only the first member 22a, notches are provided also to the second member 22b in a similar manner. Thus, even if the clip 200 of the modified example is mounted to the mounting-subject member 10 while inclined to the predetermined insertion direction, the free end side of the clip 200 can be prevented from protruding to the outside in the width direction of the side end wall portions 18.

The present invention is not limited to the embodiment described above, and it is also possible to add modifications such as various kinds of design changes to the embodiments based on the knowledge of those skilled in the art. Embodiments to which such modifications are added can also be included within the scope of the present invention.

Described above is the embodiment that the pair of extending portions 28 is provided to the first member 22a and the second member 22b; however, the present invention is not limited to this embodiment. For example, the extending portion 28 may be provided to the first member 22a, and may be extended to the second member 22b so as to cross the second member 22b.

Described above is the embodiment that the slit 17 is provided to the mounting-subject member 10; however, the present invention is not limited to this embodiment. For example, instead of the slit 17, a guide groove may be provided to the protruding portion 12 of the mounting-subject member 10 along the predetermined clip insertion direction. Movement of the extending portions 28 in the width direction is limited by the guide groove.

Described above is the embodiment that the pair of extending portions 28 includes the inclined sides at the faced tip end portions; however, the present invention is not limited to this embodiment. For example, a pair of extending portions each having a band shape may be provided and disposed side by side in the width direction while being apart in the width direction from each other. This pair of extending portions is inserted into the slit, and movement of this pair of extending portions in the width direction is limited by the guide walls 14. In addition, the opening on the free end side of the clip 20 is almost closed by the pair of extending portions, which can prevent the clips 20 from being entangled with each other. In addition, because the pair of extending portions is disposed side by side in the width direction, inhibiting warping in the lateral direction of the first member 22a and the second member 22b can be prevented.

### DESCRIPTION OF REFERENCE NUMERALS AND SIGNS

1 Clip device, 10 Mounting-subject member, 12 Protruding portion, 12a First surface, 12b Second surface, 14 Guide wall, 16 Rib, 17 Slit, 18 Side end wall portion, 20 Clip, 22a First member, 22b Second member, 24 Connecting portion, 26a First clamping hook, 26b Second clamping hook, 26c Third clamping hook, 26d Fourth clamping hook, 28a First extending portion, 28b Second extending portion

### INDUSTRIAL APPLICABILITY

The present invention relates to a clip for clamping a mounting-subject member, and a clip device including the mounting-subject member and the clip.

1. A clip device comprising a clip and a mounting-subject member to be clamped by the clip, the clip device being configured to mount the mounting-subject member on a mount-base member by locking the clip in a state of clamping the mounting-subject member on a rim of a hole portion of the mount-base member,
wherein the clip comprises:
a first member having a free end;
a second member faced to the first member and having a free end;
clamping hooks respectively provided to the first member and the second member and configured to clamp the mounting-subject member; and
an extending portion provided to at least one of the first member and the second member at a position closer to the free ends than the clamping hooks, so as to extend between the first member and the second member, and
wherein the mounting-subject member comprises:
a guide wall that is disposed along a predetermined clip insertion direction so as to face a lateral side of the extending portion, thereby limiting a movement of the extending portion in a width direction when the clip clamps the mounting-subject member.

2. The clip device of claim 1, wherein, as the guide wall, a pair of wall surfaces defining a slit are provided, the slit being formed by notching the mounting-subject member from a side where the clip is inserted.

3. The clip device of claim 1,
wherein, as the extending portion, extending portions are respectively provided on the first member and the second member, the extending portions extending so as to cross each other when seen from a lateral side of the clip.

4. The clip device of claim 3,
wherein the pair of extending portions are disposed apart from each other in the width direction of the extending portions.

5. The clip device of claim 1
wherein, as the extending portion, extending portions are respectively provided on the first member and the second member at centers in the width direction, and
wherein, as the clamping hooks, two pairs of clamping hooks are disposed at outer positions than the extending portions in the width direction.

6. The clip device of claim 1
wherein the mounting-subject member comprises a rib that extends along the guide wall and forms a part of the guide wall.

7. A clip formed from a single metallic plate, comprising:
a first member having a free end;
a second member having one end connected with the first member and the other end that is a free end and forms an opening with the free end of the first member;
a pair of clamping hooks respectively provided to the first member and the second member and configured to clamp a mounting-subject member; and
extending portions respectively provided to of the first member and the second member at a positions closer to the opening than the clamping hooks, the extending portions extending so as to cross each other when seen from a lateral side of the clip.

8. (canceled)
